(19) United States
(12) Patent Application Publication
(10) Pub. No.: US 2013/0046604 A1
(43) Pub. Date: Feb. 21, 2013

(54) VIRTUAL LOYALTY CARD PROGRAM

(71) Applicants: Alicia C. Jones, Fort Mill, SC (US); Carrie Anne Hanson, Charlotte, NC (US); Peter John Bertanzetti, Charlotte, NC (US)

(72) Inventors: Alicia C. Jones, Fort Mill, SC (US); Carrie Anne Hanson, Charlotte, NC (US); Peter John Bertanzetti, Charlotte, NC (US)

(73) Assignee: Bank of America Corporation, Charlotte, NC (US)

(21) Appl. No.: 13/211,764

(22) Filed: Aug. 17, 2011

(51) Int. Cl. G06Q 30/00; G06F 17/30

(52) U.S. Cl. 705/14.27; 705/14.49; 705/14.66; 707/825; 707/E17.044

(57) ABSTRACT

Systems and methods for providing a virtual loyalty card program are provided. The systems and methods enable a user to manage loyalty cards and receive offers. The methods provide receiving, at a computing device, loyalty card data associated with at least one loyalty card; storing the loyalty card data in a storage device; determining, via a computing device processor, a status associated with the at least one loyalty card based on the loyalty card data; and communicating, via computing device, a notification to a user based on the determined status

### BACKGROUND

Many businesses offer loyalty cards to their customers. These loyalty cards give customers access to services, products, discounts, or rewards. A customer may have many different loyalty cards that have various rewards, expiration dates, policies, and membership amounts associated with them. In some cases, a customer may be required to log into separate accounts to access rewards or pay amounts associated with the loyalty cards. Monitoring the status of each card can be difficult and time consuming, and as a result the customer may miss deadlines, fail to utilize rewards, or stop using the loyalty cards.

There are systems and methods for managing loyalty card conveniently and easily.

### BRIEF SUMMARY

Embodiments of the present invention address these and/or other needs by providing an innovative virtual loyalty card program. Advantageously, embodiments of the invention include systems and methods for managing loyalty cards.

In accordance with embodiments of the invention a method for managing loyalty card data is provided. The method comprises: receiving, at a computing device, loyalty card data associated with at least one loyalty card; storing the loyalty card data in a storage device; determining, via a computing device processor, a status associated with the at least one loyalty card based on the loyalty card data; and communicating, via computing device, a notification to a user based on the determined status. In some embodiments of the method, the loyalty card data is received from the user and/or a point of sales device.

In some embodiments of the method, the method further comprises receiving transaction data comprising one or more transactions associated with the user. In some embodiments, the method further comprises: identifying an offer available from a merchant based on the loyalty card data and/or transaction data; and presenting the offer to the user as part of the notification.

In some embodiments, the method further comprises processing a transaction associated with the offer. In some embodiments, the method further comprises identifying an offer available from a merchant; associating transaction data with the offer; and determining not to present the offer to the user based on the transaction data. In still other embodiments, the method further comprises receiving preferences from the user; and identifying an offer based on the preferences.

In some embodiments of the method, the method further comprises retrieving the loyalty card from the storage device, wherein the at least one loyalty card comprises a virtual loyalty card, the virtual loyalty card comprising a bar code. In some embodiments of the method, the method further processing a transaction associated with the at least one loyalty card. In some embodiments of the method, the method further monitoring at least one transaction associated with the at least one loyalty card; determining a reward amount associated with the at least one loyalty card upon completion of the transaction; and presenting the reward amount to the user. In some embodiments of the method, the method further comprises receiving an image of the at least one loyalty card, the at least one loyalty card comprising a bar code; and receiving transaction data associated with the bar code, the data comprising one or more transactions.

In some embodiments of the method, the notification comprises a reward amount and/or reward points. In some embodiments, the method further comprises receiving preferences from a user, wherein the preferences comprise a notification method. In some embodiments of the method, the at least one loyalty card data comprises a card number associated with the user and/or a business associated with the loyalty card.

In accordance with embodiments of the invention a computer program product for managing loyalty card data is provided. The computer program product comprising a computer-readable medium having computer-executable instructions for performing: receiving loyalty card data from a user-controlled mobile device, the data comprising at least one loyalty card; storing the loyalty card data in a storage device; and determining a status associated with at least one loyalty card based on the loyalty card data; and communicating a notification to the user based on the determined status.

In some embodiments of the computer program product, the computer-executable instructions for further performing: identifying an offer based on the loyalty card data; presenting the offer to the user; and processing a transaction associated with the offer. In some embodiments, the computer-executable instructions further perform: identifying a second offer based on the transaction; and presenting the second offer to the user. In some embodiments, the offer comprises a discount and/or rebate.

In some embodiments of the computer program product, the computer-executable instructions further perform: receiving transaction data comprising one or more transaction associated with the user. In some embodiments, the computer-executable instructions further perform: identifying an offer based on the transaction data; associating the one or more transactions with the offer; and determining not to present the offer to the user. In some embodiments, the notifications comprises a time period for receiving a reward. In some embodiments, the loyalty card data comprises a bar code; a geographical location associated with the user; and/or a geographic location associated with a business.

In some embodiments of the computer program product, the computer-executable instructions further perform: identifying rewards associated with the at least one loyalty card; filtering the rewards based on user-defined criteria to produce filtered rewards; and presenting the filtered rewards to the user. In some embodiments of the computer program product, wherein the user-defined criteria comprises a price range associated with a product and/or a geographical location. In some embodiments, the computer-executable instructions further perform: identifying rewards associated with the at least one loyalty card; comparing the rewards; and presenting a list of differences between the rewards to the user. In some embodiments, the computer-executable instructions further performs: monitoring one or more transactions associated with the at least one loyalty card; and presenting a transaction history associated with the at least one loyalty card to the user.

In accordance with embodiments of the invention, a system for managing loyalty card data is provided. The system comprising: a computer apparatus including a processor and a memory; and a loyalty card system module stored in the memory, executable by the processor and configured to receive loyalty card data from a user, the data comprising at least one loyalty card; store the loyalty card data in storage device; determine a status associated with the at least one loyalty card based on the loyalty card data; and communicate a notification to the user based on the determined status.

In some embodiments of the system, the processor is further configured to receive transaction data comprising one or more transaction associated with the user. In some embodiments, the processor is further configured to: identify an offer based on the loyalty data and/or transaction data; present the offer to the user. In some embodiments, the processor is further configured to: identify an offer based on the loyalty card data and/or transaction data; associate the one or more transaction with the offer; determine not to present the offer to the user based on the one or more transactions. In some embodiments, the loyalty card data comprises a bar code.

In some embodiments of the system, the notification comprises a reward amount and/or discount. In some embodiments, the processor is further configured to: identify rewards associated with the at least one loyalty card; filter the rewards based on user-defined criteria to produce filtered rewards; and present the filtered rewards to the user. In some embodiments, the user-defined criteria comprise a product. In some embodiments, the processor is further configured to: monitor one or more transaction associated with the at least one loyalty card; and present a transaction history associated with the loyalty card to the user.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1A-1B is a flowchart of a system and method for a virtual loyalty card program, in accordance with example embodiments of the invention;

FIG. 2 provides a block diagram illustrating a mobile virtual loyalty card program system and environment, in accordance with embodiments of the invention;

FIG. 3 provides a block diagram illustration the mobile computing device of FIG. 2, in accordance with embodiments of the invention;

FIG. 4 provides a block diagram illustrating the mobile virtual loyalty card system of FIG. 2, in accordance with embodiments of the invention;

FIG. 5 provides a block diagram illustrating the loyalty card data repository of FIG. 2, in accordance with embodiments of the invention;

FIGS. 6A-6B provide flow charts illustrating a process for using a virtual loyalty card program, in accordance with embodiments of the invention;

FIGS. 7A-7H provide screenshots of a graphical user interface used during a process for a virtual loyalty program, in accordance with embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the terms “financial institution” and “financial entity” include any organization that processes financial transactions including, but not limited to, banks, credit unions, savings and loan associations, investment companies, stock brokerages, asses management firms, insurance companies and the like.

The embodiments described herein may refer to use of a transaction or transaction event to trigger the location of the user and/or the user's mobile device. In various embodiments, occurrence of a transaction also triggers the sending of information such as offers and the like. Unless specifically limited by the context, a “transaction” refers to any communication between the user and the financial institution or other entity monitoring the user's activities. In some embodiments, for example, a transaction may refer to a purchase of goods or services, a return of goods or services, a payment transaction, a credit transaction, or other interaction involving a user's bank account. As used herein, a “bank account” refers to a credit account, a debit/deposit account, or the like. Although the phrase “bank account” includes the term “bank,” the account need not be maintained by a bank and may, instead, be maintained by other financial institutions. For example, in the context of a financial institution, a transaction may refer to one or more of a sale of goods and/or services, an account balance inquiry, a rewards transfer, an account money transfer, opening a bank application on a user's computer or mobile device, a user accessing their e-wallet or any other interaction involving the user and/or the user's device that is detectable by the financial institution. As further examples, a transaction may occur when an entity associated with the user is alerted via the transaction of the user's location. A transaction may occur when a user accesses a building, uses a rewards card, and/or performs an account balance query. A transaction may occur as a user's device establishes a wireless connection, such as a Wi-Fi connection, with a point-of-sale terminal. In some embodiments, a transaction may include one or more of the following: purchasing, renting, selling, and/or leasing goods and/or services (e.g., groceries, stamps, tickets, DVDs, vending machine items, etc.); withdrawing cash; making payments to creditors (e.g., paying monthly bills; paying federal, state, and/or local taxes and/or bills; etc.); sending remittances; transferring balances from one account to another account; loading money onto stored value cards (SVCs) and/or prepaid cards; donating to charities; and/or the like.

In some embodiments, the transaction may refer to an event and/or action or group of actions facilitated or performed by a user's device, such as a user's mobile device. Such a device may be referred to herein as a “point-of-transaction device”. A “point-of-transaction” could refer to any location, virtual location or otherwise proximate occurrence of a transaction. A “point-of-transaction device” may refer to any device used to perform a transaction, either from the user's perspective, the merchant's perspective or both. In some embodiments, the point-of-transaction device refers only to a user's device, in other embodiments it refers only to a merchant device, and in yet other embodiments, it refers to both a user device and a merchant device interacting to perform a transaction. For example, in one embodiment, the point-of-transaction device refers to the user's mobile device configured to communicate with a merchant's point of sale terminal, whereas in other embodiments, the point-of-transaction device refers to the merchant's point of sale terminal configured to communicate with a user's mobile device, and in yet other embodiments, the point-of-transaction device refers to both the user's mobile device and the merchant's point of sale terminal configured to communicate with each other to carry out a transaction.

In some embodiments, a point-of-transaction device is or includes an interactive computer terminal that is configured to initiate, perform, complete, and/or facilitate one or more transactions. A point-of-transaction device could be or include any device that a user may use to perform a transaction with an entity, such as, but not limited to, an ATM, a loyalty device such as a rewards card, loyalty card or other loyalty device, a magnetic-based payment device (e.g., a credit card, debit card, etc.), a personal identification number (PIN) payment device, a contactless payment device (e.g., a key fob), a radio frequency identification device (RFID) and the like, a computer, (e.g., a personal computer, tablet computer, desktop computer, server, laptop, etc.), a mobile device (e.g., a smartphone, cellular phone, personal digital assistant (PDA) device, MP3 device, personal GPS device, etc.), a merchant terminal, a self-service machine (e.g., vending machine, self-checkout machine, etc.), a public and/or business kiosk (e.g., an Internet kiosk, ticketing kiosk, bill pay kiosk, etc.), a gaming device, and/or various combinations of the foregoing.

In some embodiments, a point-of-transaction device is operated in a public place (e.g., on a street corner, at the doorstep of a private residence, in an open market, at a public rest stop, etc.). In other embodiments, the point-of-transaction device is additionally or alternatively operated in a place of business (e.g., in a retail store, post office, banking center, grocery store, factory floor, etc.). In accordance with some embodiments, the point-of-transaction device is not owned by the user of the point-of-transaction device. Rather, in some embodiments, the point-of-transaction device is owned by a mobile business operator or a point-of-transaction operator (e.g., merchant, vendor, salesperson, etc.). In yet other embodiments, the point-of-transaction device is owned by the financial institution offering the point-of-transaction device providing functionality in accordance with embodiments of the invention described herein.

Embodiments of the present invention provide a system and method for a virtual loyalty card program. Embodiments of the invention allow users to store one or more loyalty cards, track the status of the loyalty card, retrieve and use their loyalty card, and receive offers using a mobile virtual loyalty card program. Embodiments of the invention also allow users to set up preferences for receiving status notifications associated with the loyalty card and offers

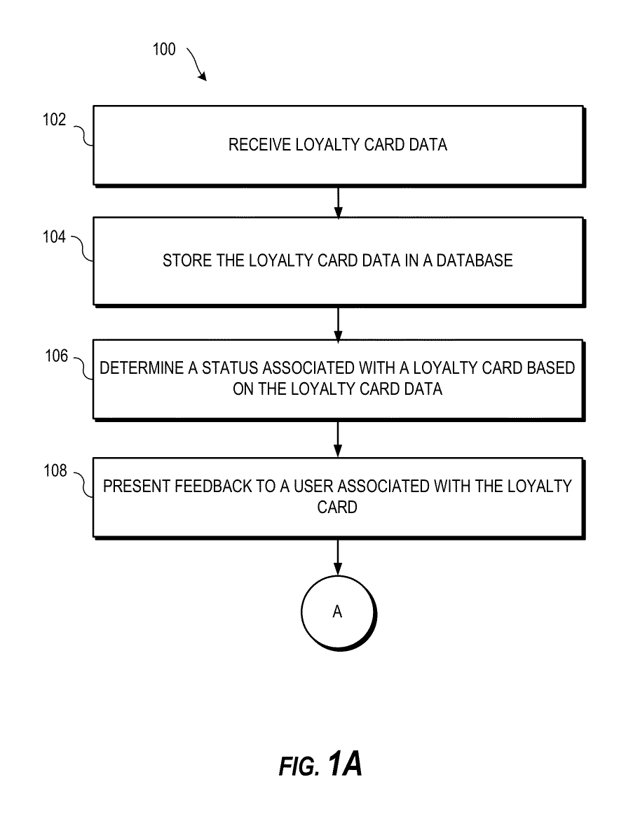

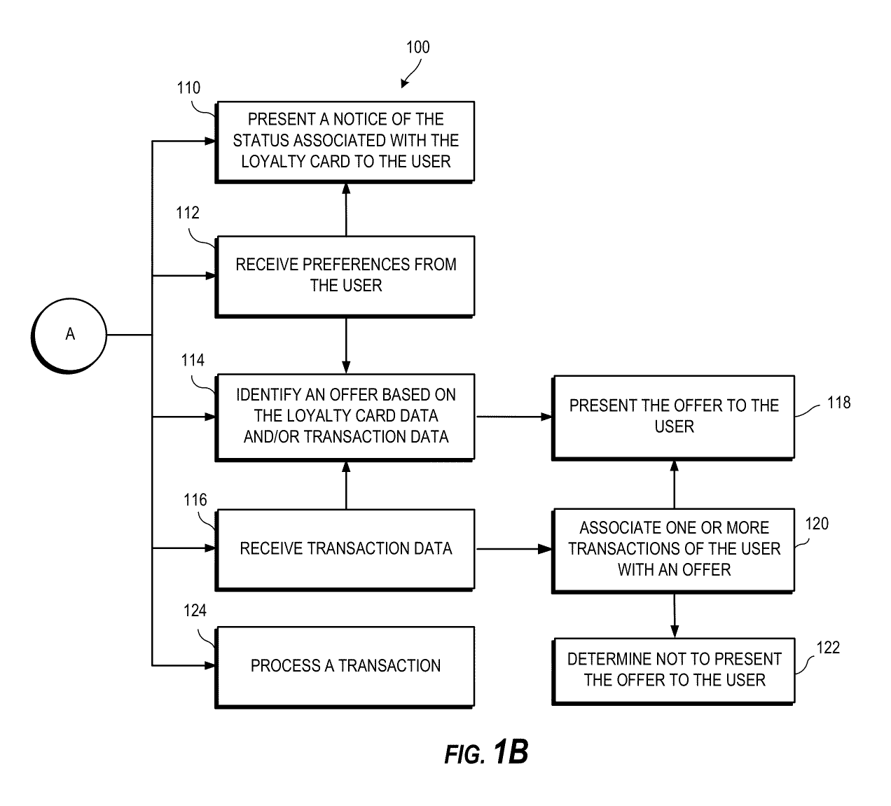

FIG. 1A is a flowchart providing an overview of a system and method 100 for a virtual loyalty card program, in accordance with one or more embodiments of the invention. It will be understood that one or more devices, such as one or more mobile device and/or one or more other computing devices and/or servers, can be configured to perform one or more steps of the method 100. In some embodiments, the one or more devices performing the steps are associated with a financial institution. In other embodiments, the one or more devices performing the steps are associated with a business, third party, and/or user.

Block 102 illustrates a step in which loyalty card data is received. The loyalty card data includes any information associated with one or more loyalty cards. Examples of the loyalty card data includes a card number; a bar code number and/or bar code image; the name on the card; information included in the application for the loyalty card including the address, phone number(s), email address, of the user; the name, address, phone number(s), website of the loyalty card issuer; expiration of the loyalty card; amounts associated with loyalty card; a geographical location associated with the loyalty card, card issuer, and/or user (e.g., zip code area, city, state, etc.), and the like. The loyalty card includes any card associated with a merchant or business. Examples of the loyalty card include membership cards, reward cards, cards for receiving discounts for sale items, store cards, debit cards, credit cards, and the like. The loyalty card may be a tangible object such as key chain card or an intangible object. In some embodiments, the loyalty card data is associated with at least one loyalty card.

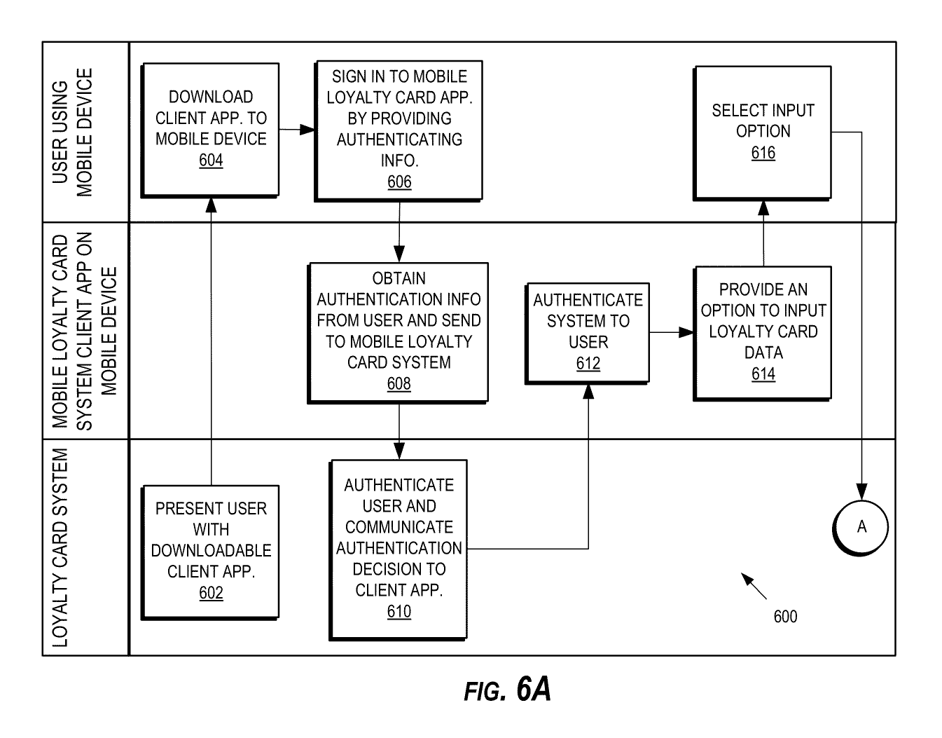

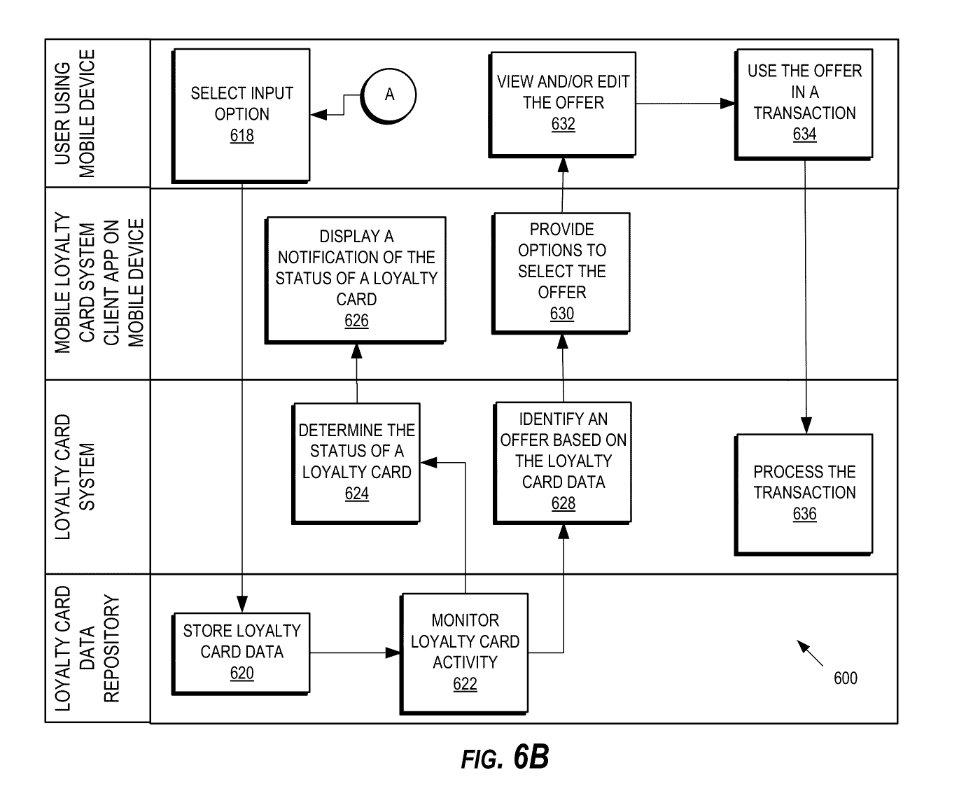

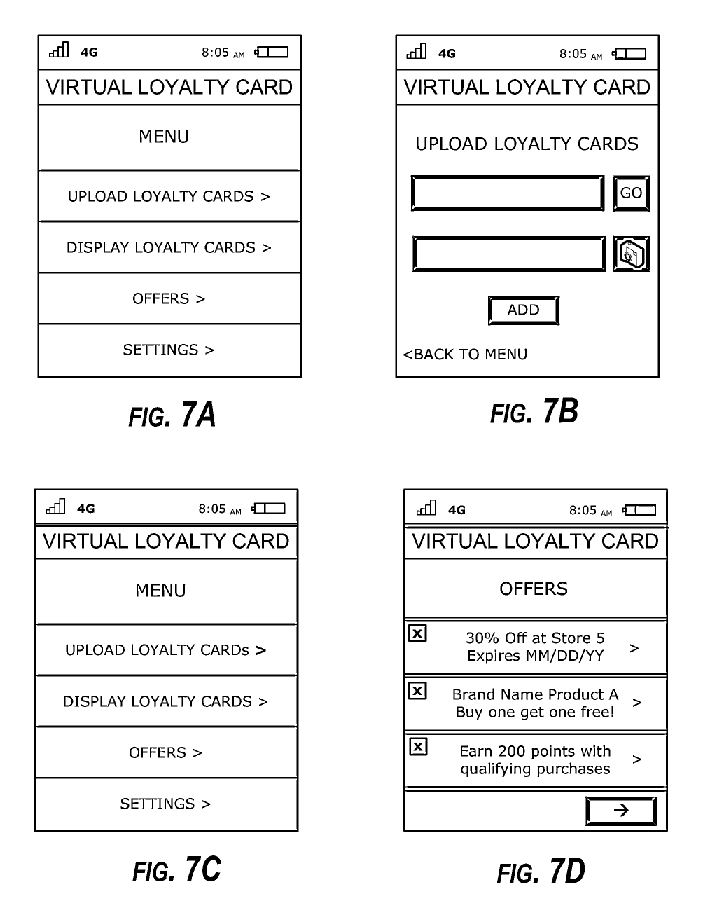

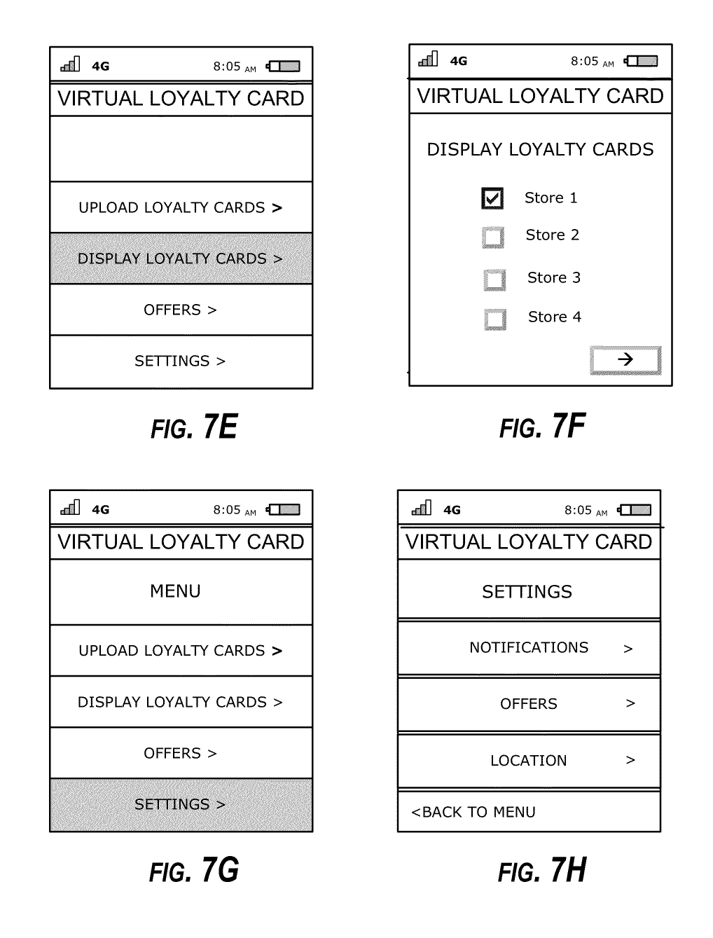

In some embodiments, the loyalty card data is received from a user. For example, a user may upload an image of a loyalty card as described in more detail with regard to FIGS. 6A-7B. In other embodiments, the loyalty card data is received from an entity associated with a point of sale device. In still other embodiments, the loyalty card data is received from a merchant associated with the loyalty card. For example, the card issuer may provide transaction data.

Block 104 illustrates a step in which the loyalty card data is stored in a database (e.g., the loyalty card data repository 500). In block 106 a status associated with a loyalty card is determined based on the loyalty card data. The status includes any information associated with the loyalty card. Examples of the status include the expiration date of the loyalty card, amounts associated with the loyalty card or memberships, updates associated with the card, membership upgrades, rewards (e.g., earned points), etc. In some embodiments, a transaction associated with a loyalty card is monitored and a reward amount associated with the loyalty card is determined upon completion of the transaction. For example, a user may be eligible for a certain number of reward points, discounts, coupons, rebates, or other rewards based on purchase transactions. The user, for example, may be eligible to receive a reward upon reaching a certain goal, such as purchasing a specific type of product, purchasing a specific brand of product, purchasing a certain quantity of products, making purchases during a specific time period, reaching a specific purchase amount, and the like. For example, a user may be eligible for a membership upgrade after being a member of an organization for one year.

Block 108 illustrates a step in which feedback is presented to a user associated with the loyalty card. For example, the user may be notified that their membership card will expire in one month and that an amount is due upon renewal of the membership. The user may also be presented with a link to the loyalty card issuer. The feedback includes a notice of the status associated with the loyalty card and an offer as described in more detail below. The user includes an individual or organization appearing on the face of the card, an individual or organization authorized to use the card, a customer or account holder of the card issuer, a member of an organization associated with the card issuer, or anyone else associated with the loyalty card.

Referring now to FIG. 1B, the method 100 is further illustrated in accordance with embodiments of the invention. Block 110 illustrates a step in which a notice of the status associated with the loyalty card is presented to the user. In some embodiments, the notice comprises a reward amount. For example, a user may be notified of rebate or cash back reward. In other embodiments, the notice comprises reward points. In still other embodiments, the notification comprises a time period in which to use the reward card in order to receive a reward. For example, the notification may inform the user that they have until the end of the month to use 200 reward points. In other embodiments, the notification may include a transaction history associated with the loyalty card. For example, the notification may include the number of purchases, the amount of a purchase, and the identity of purchases made using the loyalty card and any discounts or rewards used.

Block 112 illustrates a step in which preferences are received from a user. In some embodiments, the preferences are associated with notice of the status associated with the loyalty card. For example, preferences may include the method of receiving the notification such as text, email, phone call, etc.; the timing of the notice; the information included in the notice; and the like. The user, for example, may prefer to receive a text one month before the expiration of reward points, and may want the text to include a list of products for which the reward points can be redeemed. In other embodiments, the preferences are associated with the identification of an offer (see, e.g., block 114 of FIG. 1B). For example, the user may choose preferences related to a particular store or product.

Block 116 illustrates a step in which transaction data is received. The transaction data include one or more transactions associated with the user. The transaction data may include transactions associated with the loyalty card, as well as transactions not associated with the loyalty card. For example, the transaction data may include purchases made using the loyalty card and purchases, money withdrawals, and other transactions conducted without the loyalty card as described herein. In some embodiments, one or more transactions associated with a loyalty card are monitored and a transaction history associated with the loyalty card is presented to the user. In this way, a user can keep track of purchases made using one or more loyalty cards. Transaction data not associated with the loyalty card such as a purchase made at a specific business may be used to provide a targeted reward associated with the specific business. In some embodiments, behavior data associated with a user is received. The behavior data includes transactions associated or unassociated with the loyalty card. The behavior data may, for example, be used to indicate a user's transactional or shopping habits. The behavior data may indicate, for example, that the user only uses coupons at businesses located within a ten mile radius of the user's domicile. In one example, a mobile application associated with a user's mobile device may detect that the user has used a particular coupon or other reward at a specific geographical location (e.g., a town, a particular store, etc.) nine times in the past, and may automatically generate the coupon upon determination that the user is again in the same geographical location for the tenth time. The behavior data may further include, for example, the time of day and the day of the week a user is likely to shop at a particular business or store.

Block 114 illustrates a step in which an offer is identified based on the loyalty card data and/or transaction data. In some embodiments, the offer is identified based on the behavior data. For example, an offer for a discounted kayaking trip may be identified for a user who has a membership card for a kayaking club. The offer includes reward points, discounts, coupons, rebates, cash back, membership or account upgrades, free products or services, special privileges, or any other offer. In some embodiments, the offer is associated with the loyalty card. In some embodiments, rewards associated with the loyalty card are filtered based on user-defined criteria. The user-defined criteria include products, a price range associated with a product, a geographical location, a time period for using the rewards, and the like. For example, the user may include a price range for sports vehicles for sale within fifty miles of a home address in the user-defined criteria. In other embodiments, rewards associated with a loyalty card are compared and a list of differences between the rewards is presented to the user. The differences may include differences in a price between similar products, brand names, reward points, location of the reward, time period for using the reward, and the like. In this way, the user is given the ability to optimize the use of the rewards.

Block 118 illustrates a step in which the offer is presented to the user. In some embodiments, the offer is presented via a display on mobile device. The offer may be, for example, in the form of a text or an email. For example, a rebate for a product sold at the business associated with the loyalty card may be presented to the user. In other embodiments, the offer is not associated with a loyalty card. For example, a discount for a service at a store that is competitive to the business associated with the user's loyalty card may be presented to the user. In still other embodiments, the offer is communicated to a second user. For example, a user may want to invite friends or family to join them at a particular restaurant, and may input a preference that enables the user to forward the offers to others. The offers may be automatically communicated to the second user, or the offers may be communicated on a case by case basis. In some embodiments, the offers are communication to a second user associated with a social network. For example, the offers may be forwarded to the social network accounts of the user's friends.

Block 120 illustrates a step in which the one or more transactions of the user are associated with an offer. For example, a coupon for paint supplies may be associated with transactions for trim purchased at a hardware store. Block 122 illustrates a step in which a determination not to present the offer to the user is made. For example, if a user has purchased twelve cans of paint in the last month, a determination is made that a coupon for paint supplies will likely not be of use to the user. As another example, if a user has never purchased men's suiting, then it is likely that the user will not want a discount for a tailor made tuxedo.

Block 124 illustrates a step in which a transaction is processed. In some embodiments, a transaction associated with the loyalty card is processed. For example, a user may retrieve a virtual loyalty card using a mobile device be scanning an image of the loyalty card's bar code at a point of sales device when making a purchase or by inputting the card number or accessing an account associated with the loyalty card to make an online purchase. In other embodiments, a transaction associated with the offer is processed. For example, the user may retrieve a coupon using a mobile device and present the coupon when making a purchase. In still other embodiments, a second offer is identified based on the processed transaction associated with the offer. For example, a coupon for a tire rotation at a particular shop may be sent to a user who recently used a coupon for a free oil change at the same shop.

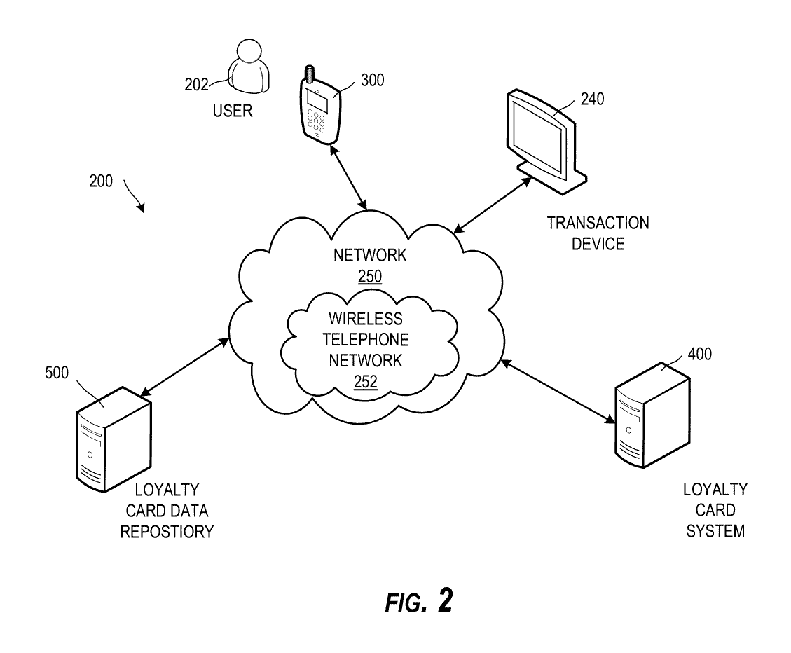

FIG. 2 provides a block diagram illustrating a mobile virtual loyalty system and environment 200, in accordance with an embodiment of the invention. As illustrated in FIG. 2, the virtual loyalty card environment 200 includes a user 202. A user of the system may be a person, a customer of a business, a person associated with a store, or any other entity capable of using a virtual loyalty card program as described herein.

The environment 200 also includes a mobile device 300 for the user 202. The mobile device 300 may be any device that employs a processor and memory and can perform computing functions, such as a personal computer or a mobile computing device. As used herein, a “mobile device” 300 is any mobile communication device, such as a cellular telecommunications device (i.e., a cell phone or mobile phone), personal digital assistant (PDA), a mobile Internet accessing device, or other mobile device.

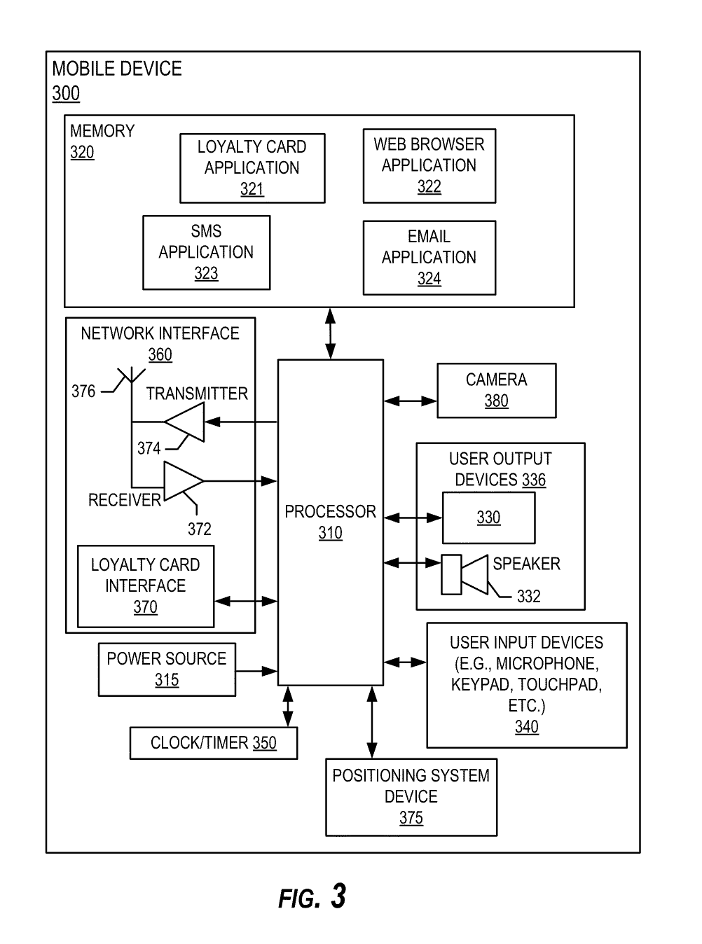

The mobile device 300 is configured to communicate over a network 250 with a loyalty card system 400 and, in some cases, at least one transaction device 240. The user's mobile device 300, the loyalty card system 400, and a loyalty card data repository 500 are each described in greater detail below with reference to FIGS. 3-5. The network 250 may include a local area network (LAN), a wide area network (WAN), and/or a global area network (GAN). The network 250 may provide for wireline, wireless, or a combination of wireline and wireless communication between devices in the network. In one embodiment, the network 250 includes the Internet. In one embodiment, the network 250 includes a wireless telephone network 252.

In general, a mobile device 300 is configured to connect with the network 250 to log the user 202 into the loyalty card system 400. The loyalty card system 400 involves authentication of a user in order to access the user's account on the loyalty card system 400. For example, the loyalty card system 400 is a system where the user 202 logs into his/her account such that the user 202 or other entity can access data that is associated with the user 202. For example, in one embodiment of the invention, the loyalty card system 400 is a loyalty card system maintained by a financial institution. In such an embodiment, the user 202 can use the mobile device 300 to log into the loyalty card system to access the user's loyalty card account. Logging into the loyalty card system 400 generally requires that the user 202 authenticate his/her identity using a user name, a passcode, a cookie, a biometric identifier, a private key, a token, and/or another authentication mechanism that is provided by the first user 202 to the loyalty card system 400 via the mobile device 300.

The loyalty card system 400 is in network communication with other devices, such as transaction devices 240 or any transaction systems and the loyalty card data repository 500. In one embodiment, the invention may provide an application download server such that software applications that support the loyalty card system 400 can be downloaded to the mobile device 300.

In some embodiments of the invention, the application download server is configured to be controlled and managed by one or more third-party data providers (not shown in FIG. 2) over the network 250. In other embodiments, the application download server is configured to be controlled and managed over the network 250 by the same entity that maintains the loyalty card system 400.

In some embodiments of the invention, the loyalty card data repository 500 is configured to be controlled and managed by one or more third-party data providers (not shown) over the network 250. In other embodiments, the loyalty card data repository 500 is configured to be controlled and managed over the network 250 by the same entity that maintains the loyalty card system 400. In other embodiments, the loyalty card data repository 500 is configured to be controlled and managed over the network 250 by the financial institution implementing the loyalty card system 400. In still other embodiments, the loyalty card data repository 500 is a part of the loyalty card system 400.

FIG. 3 provides a block diagram illustrating the consumer mobile device 300 of FIG. 2 in more detail, in accordance with embodiments of the invention. In one embodiment of the invention, the mobile device 300 is a mobile telephone. However, it should be understood, however, that a mobile telephone is merely illustrative of one type of mobile device 300 that may benefit from, employ, or otherwise be involved with embodiments of the present invention and, therefore, should not be taken to limit the scope of embodiments of the present invention. Other types of mobile devices 300 may include portable digital assistants (PDAs), pagers, mobile televisions, gaming devices, laptop computers, cameras, video recorders, audio/video player, radio, global positioning satellite (GPS) devices, or any combination of the aforementioned. In still other embodiments, the mobile device 300 includes an accelerometer device. The accelerometer device may be used to determine the location of the mobile device, including data that shows that the mobile device is moving and the direction of that movement.

The mobile device 300 generally includes a processor 310 communicably coupled to such devices as a memory 320, user output devices 336, user input devices 340, a network interface 360, a power source 315, a clock or other timer 350, a camera 380, and a positioning system device 375. The processor 310, and other processors described herein, generally include circuitry for implementing communication and/or logic functions of the mobile device 300. For example, the processor 310 may include a digital signal processor device, a microprocessor device, and various analog to digital converters, digital to analog converters, and/or other support circuits. Control and signal processing functions of the mobile device 300 are allocated between these devices according to their respective capabilities. The processor 310 thus may also include the functionality to encode and interleave messages and data prior to modulation and transmission. The processor 310 can additionally include an internal data modem. Further, the processor 310 may include functionality to operate one or more software programs, which may be stored in the memory 320. For example, the processor 310 may be capable of operating a connectivity program, such as a web browser application 322. The web browser application 322 may then allow the mobile device 300 to transmit and receive web content, such as, for example, location-based content and/or other web page content, according to a Wireless Application Protocol (WAP), Hypertext Transfer Protocol (HTTP), and/or the like.

The processor 310 is configured to use the network interface 360 to communicate with one or more other devices on the network 250. In this regard, the network interface 360 includes an antenna 376 operatively coupled to a transmitter 374 and a receiver 372 (together a “transceiver”). The processor 310 is configured to provide signals to and receive signals from the transmitter 374 and receiver 372, respectively. The signals may include signaling information in accordance with the air interface standard of the applicable cellular system of the wireless telephone network 252. In this regard, the mobile device 300 may be configured to operate with one or more air interface standards, communication protocols, modulation types, and access types. By way of illustration, the mobile device 300 may be configured to operate in accordance with any of a number of first, second, third, and/or fourth-generation communication protocols and/or the like. For example, the mobile device 300 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 300 may also be configured to operate in accordance with non-cellular communication mechanisms, such as via a wireless local area network (WLAN) or other communication/data networks.

The network interface 360 may also include a loyalty card interface 370. The loyalty card interface 370 may include software, such as encryption software, and hardware, such as a modem, for communicating information to and/or from one or more devices on a network 250. For example, the mobile device 300 may be configured so that it can be used as a credit or debit card by, for example, wirelessly communicating account numbers or other authentication information to a terminal of the network 250.

As described above, the mobile device 300 has a user interface that is, like other user interfaces described herein, made up of user output devices 336 and/or user input devices 340. The user output devices 336 include a display 330 (e.g., a liquid crystal display or the like) and a speaker 332 or other audio device, which are operatively coupled to the processor 310. The user input devices 340, which allow the mobile device 300 to receive data from a user such as the first user 310, may include any of a number of devices allowing the mobile device 300 to receive data from a user, such as a keypad, keyboard, touch-screen, touchpad, microphone, mouse, joystick, other pointer device, button, soft key, and/or other input device(s). The user interface may also include a camera 380, such as a digital camera.

The mobile device 300 may also include a positioning system device 375 that is configured to be used by a positioning system to determine a location of the mobile device 300. For example, the positioning system device 375 may include a GPS transceiver. In some embodiments, the positioning system device 375 is at least partially made up of the antenna 376, transmitter 374, and receiver 372 described above. For example, in one embodiment, triangulation of cellular signals may be used to identify the approximate location of the mobile device 300. In other embodiments, the positioning system device 375 includes a proximity sensor or transmitter, such as an RFID tag, that can sense or be sensed by devices known to be located proximate a merchant or other location to determine that the consumer mobile device 300 is located proximate these known devices.

The mobile device 300 further includes a power source 315, such as a battery, for powering various circuits and other devices that are used to operate the mobile device 300. Embodiments of the mobile device 300 may also include a clock or other timer 350 configured to determine and, in some cases, communicate actual or relative time to the processor 310 or one or more other devices.

The mobile device 300 also includes a memory 320 operatively coupled to the processor 310. As used herein, memory includes any computer readable medium (as defined herein below) configured to store data, code, or other information. The memory 320 may include volatile memory, such as volatile Random Access Memory (RAM) including a cache area for the temporary storage of data. The memory 320 may also include non-volatile memory, which can be embedded and/or may be removable. The non-volatile memory can additionally or alternatively include an electrically erasable programmable read-only memory (EEPROM), flash memory or the like.

The memory 320 can store any of a number of applications which comprise computer-executable instructions/code executed by the processor 310 to implement the functions of the mobile device 300 described herein. For example, the memory 320 may include such applications as a conventional web browser application 322, an email application 324, a short message service (SMS) application 324 for sending and receiving texts, and/or a loyalty card system client application 321. These applications also typically provide a graphical user interface (GUI) on the display 330 that allows the user 202 to communicate with the consumer mobile device 300, the loyalty card system 400, and/or other devices or systems. In one embodiment of the invention, when the user 202 decides to enroll in the loyalty card program, the user 202 downloads or otherwise obtains the loyalty card system client application from the loyalty card system 400 or from a distinct application server. In other embodiments of the invention, the user 202 interacts with the loyalty card system 400 via the web browser application 322 in addition to, or instead of, the loyalty card system client application 321.

The memory 320 can also store any of a number of pieces of information, and data, used by the mobile device 300 and the applications and devices that make up the mobile device 300 or are in communication with the mobile device 300 to implement the functions of the mobile device 300 and/or the other systems described herein. For example, the memory 320 may include such data as user authentication information, etc.

As used herein, a “processing device,” such as the processing device 310, generally refers to a device or combination of devices having circuitry used for implementing the communication and/or logic functions of a particular system. For example, a processing device 310 may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 310 may further include functionality to operate one or more software programs based on computer-executable program code thereof, which may be stored in a memory. As the phrase is used herein, a processing device 310 may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “memory” 320 generally refers to a device or combination of devices that store one or more forms of computer-readable media for storing data and/or computer-executable program code/instructions. Computer-readable media is defined in greater detail below. For example, in one embodiment, the memory device 320 includes any computer memory that provides an actual or virtual space to temporarily or permanently store data and/or commands provided to the processing device 310 when it carries out its functions described herein.

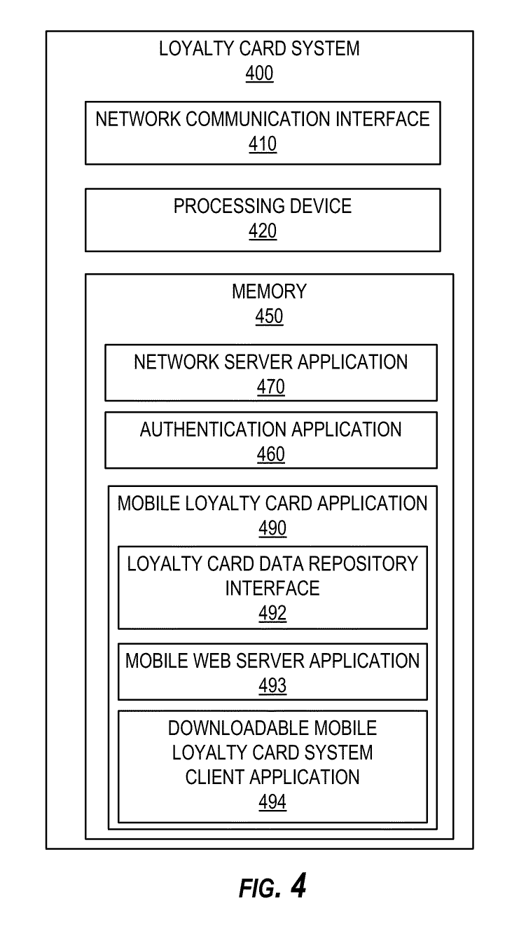

FIG. 4 provides a block diagram illustrating the loyalty card system 400 in greater detail, in accordance with an embodiment of the invention. In some embodiments, the loyalty card system 400 is operated by a financial institution. As illustrated in FIG. 4, in one embodiment of the invention, the loyalty card system 400 includes a processing device 420 operatively coupled to a network communication interface 410 and a memory device 450. In certain embodiments, the loyalty card system 400 is operated by a first entity, such as a financial institution, while in other embodiments, the loyalty card system 400 is operated by an entity other than a financial institution.

It should be understood that the memory device 450 may include one or more databases or other data structures/repositories. The memory device 450 also includes computer-executable program code that instructs the processing device 420 to operate the network communication interface 410 to perform certain communication functions of the loyalty card system 400 described herein. For example, in one embodiment of the loyalty card system 400, the memory device 450 includes, but is not limited to, a network server application 470, an authentication application 460, a user account data repository (not shown) which includes user authentication data and user account information, a loyalty card application 490 which includes an loyalty card data repository interface 492, a mobile web server application 493, a downloadable loyalty card system client application 494 and other computer-executable instructions or other data. The computer-executable program code of the network server application 470, the authentication application 460, or the loyalty card application 490 may instruct the processing device 420 to perform certain logic, data-processing, and data-storing functions of the loyalty card system 400 described herein, as well as communication functions of the loyalty card system 400.

As used herein, a “communication interface” generally includes a modem, server, transceiver, and/or other device for communicating with other devices on a network, and/or a user interface for communicating with one or more customers. Referring again to FIG. 4, the network communication interface 410 is a communication interface having one or more communication devices configured to communicate with one or more other devices on the network 250, such as the mobile device 300, the loyalty card system 400, the transaction devices 240, and the loyalty card data repository 500. The processing device 420 is configured to use the network communication interface 410 to transmit and/or receive data and/or commands to and/or from the other devices connected to the network 250.

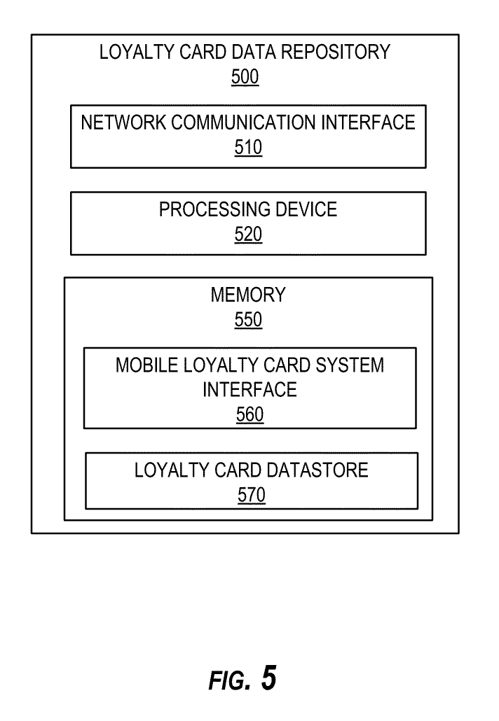

FIG. 5 provides a block diagram illustrating a loyalty card data repository 500, in accordance with an embodiment of the invention. In one embodiment of the invention, the loyalty card data repository 500 is operated by a second entity that is a different or separate entity from the first entity (e.g., the financial institution) that, in one embodiment of the invention, implements the loyalty card system 400. In one embodiment, the loyalty card data repository 500 could be part of the loyalty card system 400. In another embodiment, the loyalty card data repository 500 is a distinct entity from the loyalty card system 400. As illustrated in FIG. 5, the loyalty card data repository 500 generally includes, but is not limited to, a network communication interface 510, a processing device 520, and a memory device 550. The processing device 520 is operatively coupled to the network communication interface 510 and the memory device 550. In one embodiment of the loyalty card data repository 500, the memory device 550 stores, but is not limited to, a mobile loyalty card system interface 560 and a loyalty card data store 570. The loyalty card data store 570 stores data including, but not limited to, loyalty card data, transaction data associated and not associated with the loyalty card. In one embodiment of the invention, both the mobile loyalty card system interface 560 and the loyalty card data store 570 may associate with applications having computer-executable program code that instructs the processing device 520 to operate the network communication interface 510 to perform certain communication functions involving the loyalty card data store 570 described herein. In one embodiment, the computer-executable program code of an application associated with the loyalty card data store 570 may also instruct the processing device 520 to perform certain logic, data processing, and data storing functions of the application associated with the loyalty card data store 570 described herein.

The network communication interface 510 is a communication interface having one or more communication devices configured to communicate with one or more other devices on the network 250. The processing device 520 is configured to use the network communication interface 510 to receive information from and/or provide information and commands to the mobile device 300, the transaction device 240, the loyalty card data repository 500, the loyalty card system 400 and/or other devices via the network 250. In some embodiments, the processing device 520 also uses the network communication interface 510 to access other devices on the network 250, such as one or more web servers of one or more third-party data providers. In some embodiments, one or more of the devices described herein may be operated by a second entity so that the third-party controls the various functions involving the loyalty card data repository 500. For example, in one embodiment of the invention, although the loyalty card system 400 is operated by a first entity (e.g., a financial institution), a second entity operates the loyalty card data repository 500 that stores the loyalty card details for the customer's financial institution accounts and other information about customers.

As described above, the processing device 520 is configured to use the network communication interface 510 to gather data from the various data sources. The processing device 520 stores the data that it receives in the memory device 550. In one embodiment of the invention, an application server is provided to support various supporting systems on the network 250, including the wireless telephone network 252. The application server includes a network communication interface, a processing device, and a memory device. The network communication interface and the processing device are similar to the previously described network communication interface 510 and the processing device 520 previously described. For example, the processing device is operatively coupled to the network communication interface and the memory device. In one embodiment of the application server, the memory device includes a network browsing application having computer-executable program code that instructs the processing device to operate the network communication interface to perform certain communication functions of the application download server described herein. In some embodiments of the invention, the application download server provides applications that are to be downloaded to a qualified customer's mobile device or personal computing device.

FIGS. 6A-6B provide flow charts illustrating a process 600 for a loyalty card program using a mobile device, in accordance with an embodiment of the invention. FIGS. 6A-6B illustrate the flow chart in terms of “swim lanes” associated with entities which may perform the operations in each respective swim lane. The entities illustrated in the exemplary Figures are a loyalty card system, a user using a mobile device, and a loyalty card data repository. However, it should be noted that other entities could also be involved and some embodiments of the invention may not be limited to the three entities illustrated in FIGS. 6A-6B. Additionally, it should be understood that, in other embodiments of the invention, the entities need not be required to perform the actions illustrated in each respective swim lane. For example, some of the process steps described herein may be performed by the first entity (or other entities) even though the element may be illustrated as in the swim lane of the second entity. Similarly, in some embodiments, some of the process steps may be performed by the second entity (or other entities) even though the element may be illustrated as in the swim lane of the first entity.

The process begins at block 602 of FIG. 6A where a loyalty card system 400 presents a user with a downloadable client application so that the user can participate in a mobile virtual loyalty card program. In some embodiments, the loyalty card system 400 presents the terms of the virtual loyalty card program that will govern the operation of the program. In some embodiments, the user can read the terms on the user's mobile device 300, whereas in other embodiments, the user can only read the terms on a personal computing device. In still other embodiments, the user accepts the terms of the loyalty card service by activating an appropriate button on the mobile webpage.

The next step in the process is illustrated in block 604 where the user 202 using mobile device 400 to download the client application to the mobile device.

The next step in the process is illustrated in block 606 of FIG. 6A where the user 202 signs in to the loyalty card system 400 using the client application by providing appropriate authentication information.

The next step in the process is illustrated in 608 of FIG. 6A where the mobile loyalty card client application 494 on the mobile device 300 obtains authentication information from the user and sends the authentication information to the loyalty card system 400. For example, the user may input an identifier such as a code, an email address, a user name into the appropriate field and a security code such as a password in the required security field. The user may additionally be required to answer a security question, input text, identify a picture, and the like.

The next step in the process is illustrated in 610 of FIG. 6A where the loyalty card system 400 authenticates the user 202 and communicates the authentication decision to the mobile loyalty card system client application 494.

The next step in the process is illustrated in 612 of FIG. 6A where the mobile loyalty card system client application 494 authenticates the system to the user 202. In one embodiment of the invention, the authentication is achieved using a web-based security system that provides mutual authentication between end-users and websites. In a challenge-response process of security system, the user has to identify himself or herself on a secure website by entering a username. Subsequently, the website authenticates itself to the user by displaying an image and an accompanying phrase that the user had previously configured. If the user recognizes this image and the accompanying phrase, the user can authenticate himself or herself to the website by entering a password. Other embodiments of the invention may use other authentication systems.

The next step in the process is illustrated in block 614 of FIG. 6A where the loyalty card system client application 494 provides a mobile virtual loyalty card program menu including an option to input loyalty card data. FIG. 7A illustrates the mobile virtual loyalty card program menu, including options to upload a loyalty card and display loyalty cards, as well as offers and settings options.

The next step in the process is illustrated in block 616 of FIG. 6A where the user 202 selects the input loyalty card option from the menu, such as the upload loyalty card option displayed in FIG. 7A.

The next step in the process is illustrated in block 618 of FIG. 6B where the user 202 inputs the loyalty card data. As shown in FIG. 7B, a field for manually inputting a card number and a field for uploading an image of the card number and/or bar code are provided. The user can press the “ADD” button to upload the card number and/or image. The user may also input other information including a mobile number, an email address, and the like. In some embodiments the user may additional input user-defined preferences. As shown in FIGS. 7G-7H, the user may select the “Settings” on the menu screen and input preferences with regard to notifications, offers, and/or locations. For example, the user may input a preferred location, offer preferences such as a minimum discount amount or preferred coupons for a particular merchant, or notification methods such as instructions to forward offers to friends associated with a social network.

The next step in the process is illustrated in block 620 of FIG. 6B where the loyalty card data repository 494 stores the loyalty card data.

The next step in the process is illustrated in block 622 of FIG. 6B where the loyalty card system 400 monitors loyalty card activity. In some embodiments, the loyalty card system 400 tracks one or more transactions associated with a loyalty card. For example, the loyalty card system 400 monitors purchases made using the loyalty card.

The next step in the process is illustrated in 624 of FIG. 6B where the loyalty card system 400 determines the status of a loyalty card.

The next step in the process is illustrated in block 626 of FIG. 6B where the loyalty card system client application 494 displays a notification of the status of the loyalty card. In some embodiments, the notification is a “pop-up” message that appears when the user 202 logs into the virtual loyalty card program application. In other embodiments, the notification includes a text message and/or email.

The next step in the process is illustrated in block 628 of FIG. 6B where the loyalty card system 400 identifies an offer based on the loyalty card data. In some embodiments, an offer is identified based on transaction data. The offer includes rewards, discounts, coupons, and the like as described herein.

The next step in the process is illustrated in block 630 of FIG. 6B where the loyalty card system client application 494 provides options to select the offer. FIG. 7C reflects an “Offers” option on the menu. In block 632, the user 202 views and/or edits the offer. When the user 202 selects the “Offers” option in FIG. 7C, a list of offers appears as shown in FIG. 7D. The user 202 can select a particular offer to view details about the offer or the user 202 can click on the “x” box to delete an offer. The details of the offer includes a code number, a bar code image, the address, phone number, and/or website of the business associated with the address, the expiration of the offer, the terms and conditions of the offer, and the like.

The next step in the process is illustrated in block 634 of FIG. 6B where the user 202 can use the offer in a transaction. For example, the user 202 can click on the offer to display the bar card image of the offer when making a purchase. In some embodiments, the user uses the offer in a transaction associated with the loyalty card. As shown in FIG. 7E, the user 202 can select the “Display loyalty cards” option. A list of loyalty cards appear upon selection of the display option as shown in FIG. 7F. The name of the store or card issuer appears in the list and the user 202 can select the desired loyalty cards by selecting the check box next to the store name. In some embodiments, the loyalty card system client application 494 presents a bar code image associated with a loyalty card. The user 202 can then use the bar code image at a point of sales device. The transaction associated with the loyalty card, in some embodiments, is stored in the loyalty card data repository 500.

The next step in the process is illustrated in block 634 of FIG. 6B where the loyalty card system 400 processes the transaction. In some embodiments, the loyalty card system 400 is associated with a financial institution. The financial institution may process, for example, a purchase made using the offer.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A method for managing loyalty card data, the method comprising:
receiving, at a computing device, loyalty card data associated with at least one loyalty card;
storing the loyalty card data in a storage device;
determining, via a computing device processor, a status associated with the at least one loyalty card based on the loyalty card data; and
communicating, via computing device, a notification to a user based on the determined status.

2. The method of claim 1, wherein the loyalty card data is received from the user.

3. The method of claim 1, wherein the loyalty card data is received from an entity associated with a point of sales device.

4. The method of claim 1, further comprising receiving transaction data comprising one or more transactions associated with the user.

5. The method of claim 4, further comprising:
identifying an offer available from a merchant based on the loyalty card data and/or transaction data; and
presenting the offer to the user as part of the notification.

6. The method of claim 5, further comprising processing a transaction associated with the offer.

7. The method of claim 4, further comprising:
identifying an offer available from a merchant;
associating transaction data with the offer; and
determining not to present the offer to the user based on the transaction data.

8. The method of claim 1, further comprising:
receiving preferences from the user; and
identifying an offer based on the preferences.

9. The method of claim 1, further comprising retrieving the loyalty card from the storage device, wherein the at least one loyalty card comprises a virtual loyalty card, the virtual loyalty card comprising a bar code.

10. The method of claim 1, further comprising processing a transaction associated with the at least one loyalty card.

11. The method of claim 1, further comprising:
monitoring at least one transaction associated with the at least one loyalty card;
determining a reward amount associated with the at least one loyalty card upon completion of the transaction; and
presenting the reward amount to the user.

12. The method of claim 1, the receiving loyalty card data further comprising:
receiving an image of the at least one loyalty card, the at least one loyalty card comprising a bar code; and
receiving transaction data associated with the bar code, the data comprising one or more transactions.

13. The method of claim 1, wherein the notification comprises a reward amount.

14. The method of claim 1, wherein the notification comprises reward points.

15. The method of claim 1, further comprising:
receiving preferences from a user, wherein the preferences comprise a notification method.

16. The method of claim 1, wherein the at least one loyalty card data comprises a card number associated with the user.

17. The method of claim 1, wherein the loyalty card data comprises a business associated with the loyalty card.

18. A computer program product for managing loyalty card data, the computer program product comprising a computer-readable medium having computer-executable instructions for performing:
receiving loyalty card data from a user-controlled mobile device, the data comprising at least one loyalty card;
storing the loyalty card data in a storage device; and
determining a status associated with at least one loyalty card based on the loyalty card data; and
communicating a notification to the user based on the determined status.

19. The computer program product of claim 18, the computer-executable instructions for further performing:
identifying an offer based on the loyalty card data;
presenting the offer to the user; and
processing a transaction associated with the offer.

20. The computer program product of claim of claim 19, the computer-executable instructions further perform:
identifying a second offer based on the transaction; and
presenting the second offer to the user.

21. The computer program product of claim 19, wherein the offer comprises a discount.

22. The computer program product of claim 19, wherein the offer comprises a rebate.

23. The computer program product of claim 18, wherein the computer-executable instructions further perform:
receiving transaction data comprising one or more transaction associated with the user.

24. The computer program product of claim 23, wherein the computer-executable instructions further perform:
identifying an offer based on the transaction data;
associating the one or more transactions with the offer; and
determining not to present the offer to the user.

25. The computer program product of claim 18, wherein the notifications comprises a time period for receiving a reward.

26. The computer program product of claim 18, wherein the loyalty card data comprises a bar code.

27. The computer program product of claim 18, wherein the loyalty card data comprises a geographic location associated with the user.

28. The computer program product of claim 18, wherein the loyalty card data comprises a geographic location associated with a business.

29. The computer program product of claim 18, wherein the computer-executable instructions for further perform:
identifying rewards associated with the at least one loyalty card;
filtering the rewards based on user-defined criteria to produce filtered rewards; and
presenting the filtered rewards to the user.

30. The computer program product of claim 29, wherein the user-defined criteria comprises a price range associated with a product.

31. The computer program product of claim 29, wherein the user-defined criteria comprises a geographical location.

32. The computer program product of claim 18, the computer-executable instructions further perform:
identifying rewards associated with the at least one loyalty card;
comparing the rewards; and
presenting a list of differences between the rewards to the user.

33. The computer program product of claim 18, wherein the computer-executable instructions further performs:
monitoring one or more transactions associated with the at least one loyalty card; and
presenting a transaction history associated with the at least one loyalty card to the user.

34. A system for managing loyalty card data, the system comprising:
a computer apparatus including a processor and a memory; and
a loyalty card system module stored in the memory, executable by the processor and configured to receive loyalty card data from a user, the data comprising at lest one loyalty card;
store the loyalty card data in storage device; determine a status associated with the at least one loyalty card based on the loyalty card data; and communicate a notification to the user based on the determined status.

35. The system of claim 34, wherein the processor is further configured to receive transaction data comprising one or more transaction associated with the user.

36. The system of claim 35, wherein the processor is further configured to:
identify an offer based on the loyalty data and/or transaction data;
present the offer to the user.

37. The system of claim 35, wherein the processor is further configured to:
identify an offer based on the loyalty card data and/or transaction data;
associate the one or more transaction with the offer;
determine not to present the offer to the user based on the one or more transactions.

38. The system of claim 34, wherein the loyalty card data comprises a bar code.

39. The system of claim 34, wherein the notification comprises a reward amount.

40. The system of claim 34, wherein the notification comprises a discount.

41. The system of claim 34, wherein the processor is further configured to:
identify rewards associated with the at least one loyalty card;
filter the rewards based on user-defined criteria to produce filtered rewards; and
present the filtered rewards to the user.

42. The system of claim 41, wherein the user-defined criteria comprises a product.

43. The system of claim 34, wherein the processor is further configured to:
monitor one or more transaction associated with the at least one loyalty card; and
present a transaction history associated with the loyalty card to the user.
